(19) United States
(12) Patent Application Publication
(10) Pub. No.: US 2024/0099530 A1
(43) Pub. Date: Mar. 28, 2024

(54) Dust and gas separator and vacuum cleaner

(71) Applicant: SHENZHEN CHENBEI TECHNOLOGY CO., LTD., Shenzhen (CN)

(72) Inventor: Junping Li, SHENZHEN (CN)

(73) Assignee: SHENZHEN CHENBEI TECHNOLOGY CO., LTD., Shenzhen (CN)

(21) Appl. No.: 18/368,430

(22) Filed: Sep. 14, 2023

(30) Foreign Application Priority Data
Sep. 16, 2022 (CN) CN202211127465.4

(51) Int. Cl. A47L 9/16; A47L 5/24; A47L 9/12; A47L 9/22; B04C 3/04; B04C 3/06; B04C 9/00

(52) U.S. Cl. CPC A47L 9/1608; A47L 5/24; A47L 9/12; A47L 9/1641; A47L 9/165; A47L 9/1658; A47L 9/1683; A47L 9/1691; A47L 9/22; B04C 3/04; B04C 3/06; B04C 9/00; B04C 2009/002; B04C 2009/005

(57) ABSTRACT

A dust-air separation device and vacuum cleaner comprises a housing with an air inlet channel, a cyclone separation chamber, and a dust collection chamber, the air inlet channel and the dust collection chamber are connected to the cyclone separation chamber, and an air outlet is formed on the housing; the inner peripheral wall of the cyclone separation chamber is provided with an air deflector extending along the flow direction of the airflow in the cyclone separation chamber. A first separator and the second separator are respectively located on opposite sides of the air deflector along the axial direction of the cyclone separation chamber, and the first separator and the second separator are both connected to the air outlet. The dust-air separation device reduces filter clogging and sudden drops in suction power such that the device has better vacuuming performance.

### CROSS-REFERENCE TO RELATED APPLICATIONS

This application claims priority to and benefit of the earlier Chinese Patent Application No. CN202211127465.4 filed on Sep. 16, 2022, the content of which is incorporated herein by reference in its entirety.

### TECHNICAL FIELD

The present application belongs to the technical field of vacuuming devices and particularly relates to a dust-air separation device and a vacuum cleaner.

### BACKGROUND

Vacuum cleaners (e.g., dust and gas and/or dust-air separation devices) are the most common cleaning tools in daily life. Vacuum cleaners have reduced the difficulty of manual cleaning and other household chores. Among related technologies, a single-cone cyclone dust-air separation device is often used in the vacuum cleaner. The design of the structure of the chamber in the single-cone cyclone separation device is not ideal. The airflow is not turbulent, resulting in excessive loss of airflow kinetic energy and inefficient dust-air separation. Filter clogging occurs easily in the vacuum cleaner during use, which in turn causes the vacuum cleaner to experience a sharp drop in suction power during use and also causes a performance loss of the vacuum cleaner.

### BRIEF DESCRIPTION OF THE FIGURES

These and other features and advantages of the present disclosure will become appreciated, as the same becomes better understood with reference to the specification, claims and drawings herein.

FIG. 1 is a structural schematic diagram of a vacuum cleaner provided by an embodiment of the present invention.

FIG. 2 is a cross-sectional view of the vacuum cleaner shown in FIG. 1.

FIG. 3 is a schematic diagram of a first angle of view of the dust-air separation device shown in FIG. 1.

FIG. 4 is a schematic diagram of a second angle of view of the dust-air separation device shown in FIG. 1.

FIG. 5 is a cross-sectional view in a first direction of the dust-air separation device shown in FIG. 3.

FIG. 6 is a cross-sectional view in a first direction of the dust-air separation device in another embodiment of the present invention.

FIG. 7 is a cross-sectional view in a first direction of the dust-air separation device in other embodiments of the present invention.

FIG. 8 is a cross-sectional view in a second direction of the dust-air separation device shown in FIG. 3.

FIG. 9 is an exploded-view diagram of the dust-air separation device shown in FIG. 3.

FIG. 10 is a structural schematic view of a third angle of view of the air outlet bracket shown in FIG. 9.

FIG. 11 is a structural schematic view of a fourth angle of view of the air outlet bracket shown in FIG. 9.

FIG. 12 is a structural schematic view of an air outlet bracket in another embodiment of the dust-air separation device of the present invention.

FIG. 13 is a structural schematic view of the dust cup shown in FIG. 9.

FIG. 14 is a structural schematic view of a dust cup in other embodiments of the dust-air separation device of the present invention.

FIG. 15 is a structural schematic view of a dust cup in other embodiments of the dust-air separation device of the present invention.

### SUMMARY OF THE INVENTION

The present invention provides an improved dust-air separation device to solve the technical problems in prior art dust-air separation devices, such as a vacuum cleaners, that experience a sharp decline in suction power and a large loss of performance.

In order to achieve the above, the technical solution adopted in the present application is: A dust-air separation device comprising a housing having an air inlet channel, a cyclone separation chamber, and a dust collection chamber formed therein. The air inlet channel and the dust collection chamber are both connected to the cyclone separation chamber and an air outlet is formed on the housing. The dust-air separation device further comprises a first separator and a second separator disposed within the cyclone separation chamber. The cyclone separation chamber has an air deflector extending along an airflow direction within the cyclone separation chamber disposed on an inner peripheral wall, the first separator and the second separator are located on opposite sides of the air deflector along an axial direction of the cyclone separation chamber, and the first separator and the second separator are both connected to the air outlet.

Optionally, the thickness of the air deflector gradually increases along a direction of airflow within the cyclone separation chamber.

Optionally, a plane perpendicular to an axis of the cyclone separation chamber is an auxiliary plane on which an auxiliary line is provided, the auxiliary line being perpendicular to an axis of the air inlet channel. The projection line of the air intake edge of the air deflector on the auxiliary plane is set at an included angle with the auxiliary line and the included angle ranges from 300 to 120°. Optionally, the dust-air separation device further comprises a connecting column formed with a connecting hole within the connecting column, the first separator and the second separator being mounted on opposite ends of the connecting column and both connecting to the connecting hole; the connecting column being mounted on the air deflector, the interior of the air deflector forming an exhaust channel, and the exhaust channel connecting to the air outlet and the connecting hole.

Optionally, the dust-air separation device further comprises a partition mounted within the connecting hole and dividing the connecting hole into a first hole segment that connects to the first separator and the exhaust channel and a second hole segment that connects to the second separator and the exhaust channel.

Optionally, the ratio of the projected area of the partition along the axial direction of the connecting hole to the cross-sectional area of the connecting hole is greater than 0.75.

Optionally, the opposite side walls of the air outlet end of the air inlet channel along the axial direction of the cyclone separation chamber gradually move away from each other along the flow direction of the airflow.

Optionally, the cyclone separation chamber is formed with a dust outlet connected to the dust collection chamber. Both opposite sides of the dust outlet along the axial direction of the cyclone separation chamber are flush with both ends of the cyclone separation chamber.

Optionally, the housing comprises an air outlet plate and a dust cup formed with the air inlet channel and the dust collection chamber; the air outlet plate is detachably mounted on the dust cup and surrounds the dust cup to form the cyclone separation chamber, the air deflector is mounted on the air outlet plate, and the air outlet is formed on the air outlet plate.

Optionally, the dust-air separation device also comprises a first lock, one end of the air outlet plate is rotatably connected with the dust cup, and the other end of the air outlet plate is connected with the dust cup through the first lock.

One or more of the above technical solutions in the dust-air separation device provided by the present application have at least one of the following technical effects: The dust-air separation device comprises a first separator and a second separator and the inner peripheral wall of the cyclone separation chamber is provided with an air deflector. The air deflector extends along a flow direction of the airflow within the cyclone separation chamber. At the same time, the first separator and the second separator are located on opposite sides of the air deflector along an axial direction of the cyclone separation chamber. In this way, airflow carrying impurities, dust, etc. flows through the air inlet channel into the cyclone separation chamber and then flows under the guidance of the air deflector. The air deflector divides the airflow into two parts. The two parts of the airflow are discharged from the first separator and the second separator, respectively, and are then finally discharged through the air outlet into the subsequent device (i.e., the air duct of the handheld device), wherein the airflow is divided into two parts under the guidance of the air deflector. The two parts of the airflow are rotated to opposite sides of the air deflector and discharged from the first separator and the second separator, respectively, located on opposite sides of the air deflector. This reduces the mutual impact of the two parts of the airflow, reduces vortex flow within the cyclone separation chamber, increases airflow patency, increases the flow rate of the airflow, and improves dust-air separation efficiency. At the same time, it can also reduce the cessation of rotation directly into the first separator and the second separator after some of the dust impacted by airflow, reducing the dust contained in the airflow discharged from the cyclone separation chamber and thereby avoiding subsequent filter clogging; at the same time, the two parts of the airflow are discharged from the first separator and second separator located on both sides of the air deflector, respectively. In this way, the problem of uneven local flow rate caused by the two parts of the air being concentrated in one position can be avoided, improving the smoothness of airflow and dust-air separation performance; in addition, the arrangement of the first separator and the second separator can increase the exhaust area of the cyclone separation chamber, which helps reduce the exhaust resistance and further improve the dust-air separation efficiency. The smoothness of the flow of air in the dust-air separation device is good, the loss of airflow kinetic energy is small, and the efficiency of dust-air separation is high, so that vacuum cleaners with the dust-air separation device do not experience filter clogging and sudden drops in suction power. At the same time, the loss of airflow kinetic energy is reduced, which can also make the vacuum cleaner have better vacuuming performance.

In another embodiment of the present application, a vacuum cleaner is provided and comprises the dust-air separation device described above.

In the vacuum cleaner of the present application, due to the use of the above dust-air separation device, the smoothness of the flow of air in the dust-air separation device is good, the loss of airflow kinetic energy is small, and the efficiency of dust-air separation is high, so that the vacuum cleaner does not experience filter clogging and sudden drops in suction power. At the same time, the loss of airflow kinetic energy is reduced, which can also make the vacuum cleaner have better vacuuming performance.

### DETAILED DESCRIPTION

The present invention will be described with reference to the accompanying drawings, in which exemplary embodiments of the present invention are shown. It is noted that, in the accompanying drawings, the same components are denoted by the same reference numerals as possible. In addition, detailed descriptions of well-known functions and configurations that may obscure the subject matter of the present invention will be omitted.

In the descriptions of the present application, it is to be understood that the orientation or location relationships indicated by the terms “length,” “width,” “upper,” “lower,” “front,” “rear,” “left,” “right,” “vertical,” “horizontal,” “top,” “bottom,” “inner,” “outer,” etc. are based on the orientation or location relationships shown in the attached drawings. They are merely for the purpose of describing the present application and simplifying the descriptions and are not intended to indicate or imply that the device or element referred to must have a particular orientation or be constructed and operated in a particular orientation, and thus cannot be construed as limitations of the present application.

Furthermore, the terms “first” and “second” are used for descriptive purposes only and are not to be construed as indicating or implying relative importance or implicitly indicating the number of technical features indicated. As such, features defined as “first” and “second” may explicitly or implicitly include one or more of the features. In the descriptions of the present application, “multiple” means two or more, unless specifically defined otherwise.

In the present application, unless otherwise expressly stipulated and defined, the terms “mounting,” “connected,” “connection,” “fixed,” and other terms should be understood in a broad sense. For example, they can be fixed connections, detachable connections, or integrated; they can be mechanical connections or electrical connections; they can be directly connected or indirectly connected through intermediate media, and they can be the connection between two elements or the mutual interaction between two elements. For those of ordinary skill in the art, the specific meaning of the above terms in the present application may be understood on a case-by-case basis.

It is also worth noting that the same reference numerals represent the same component part or the same part in the embodiments of the present application, and for the same parts in the embodiments of the present application, reference numerals may only be marked with one part or component as an example. It should be understood that for other identical parts or components, the reference numerals also apply.

In the present application, the terms “one embodiment,” “some embodiments,” “examples,” “specific examples,” or “some examples,” etc. mean that specific features, structures, materials, or characteristics described in connection with the embodiment or example are included in at least one embodiment or example of the present application. In the present specification, schematic representations of the above-described terms are not necessarily directed at the same embodiment or example.

Moreover, the specific features, structures, materials, or characteristics described may be combined in a suitable manner in any one or more embodiments or examples. Further, as long as there is no contradiction, one skilled in the art may combine and assemble features of different embodiments or examples described in the present specification.

The embodiment of the present application provides a dust-air separation device 100, which is used in a vacuum cleaner 1 to separate dust, debris, etc. from air, so as to realize vacuum operation; in particular, the dust-air separation device 100 may be used in a vacuum cleaner 1 such as a horizontal vacuum cleaner, a vertical vacuum cleaner, a wand vacuum cleaner, a handheld vacuum cleaner, etc. Its specific application may be selected according to the actual situation and is not defined here;

In order to describe clearly the technical solution of the present application, embodiments of the present application are illustrated with the application of the dust-air separation device 100 in a handheld vacuum cleaner as an example.

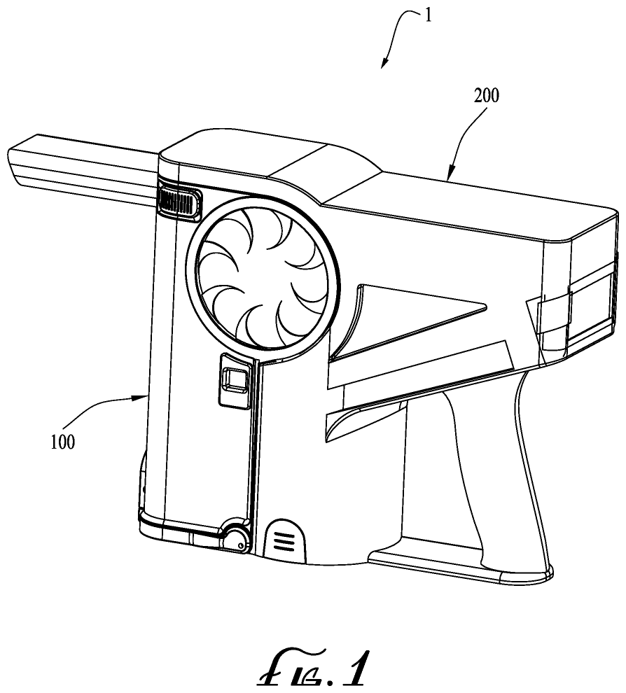

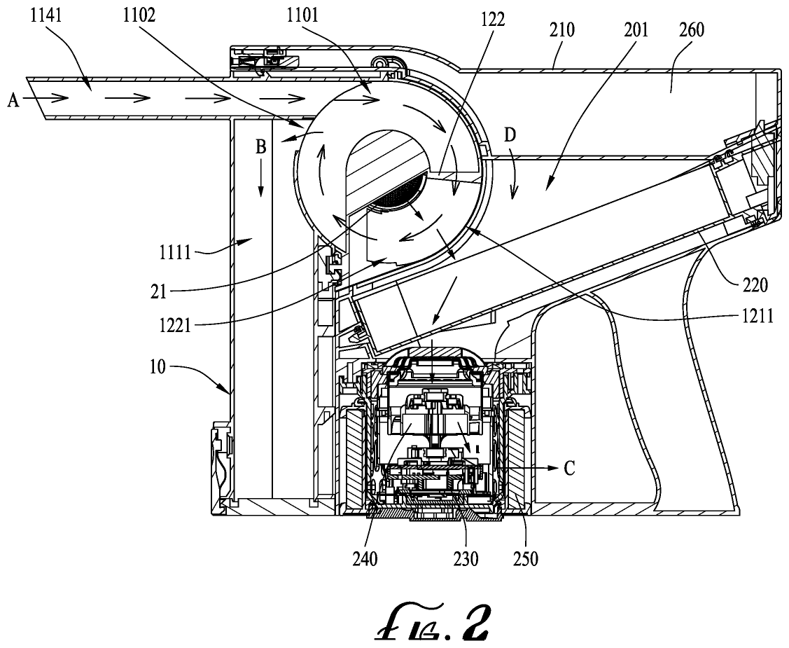

With reference to FIG. 1 and FIG. 2, the vacuum cleaner 1 comprises a dust-air separation device 100 and a handheld device 200. The handheld device 200 draws a vacuum into the dust-air separation device 100, so that an airflow with impurities, dust, etc. enters the dust-air separation device 100. After the dust-air separation device 100 removes impurities, dust, etc., the airflow is discharged through the handheld device 200; specifically, the handheld device 200 comprises an outer housing 210, an air inlet filter 220, a motor 230, an impeller 240, and an air outlet filter 250. An air duct 201 is formed in the housing 10. The air inlet filter 220, the motor 230, and the impeller 240 are sequentially arranged in the air duct 201 from top to bottom. The air outlet filter 250 is arranged around the motor 230 and the air inlet of the air duct 201 is connected to the air outlet 1211 of the dust-air separation device 100; when the vacuum cleaner 1 is operating, the motor 230 drives the impeller 240 to rotate to draw a vacuum into the air duct 201 and suck the airflow discharged from the dust-air separation device 100 into the air duct 201. Subsequently, after being filtered by the air inlet filter 220, the airflow is discharged from the outer housing 210 through the impeller 240 and the air outlet filter 250, completing the vacuuming operation. Wherein, after dust-air separation, the air needs to be filtered through the air inlet filter 220 and the air outlet filter 250 so as to avoid secondary pollution.

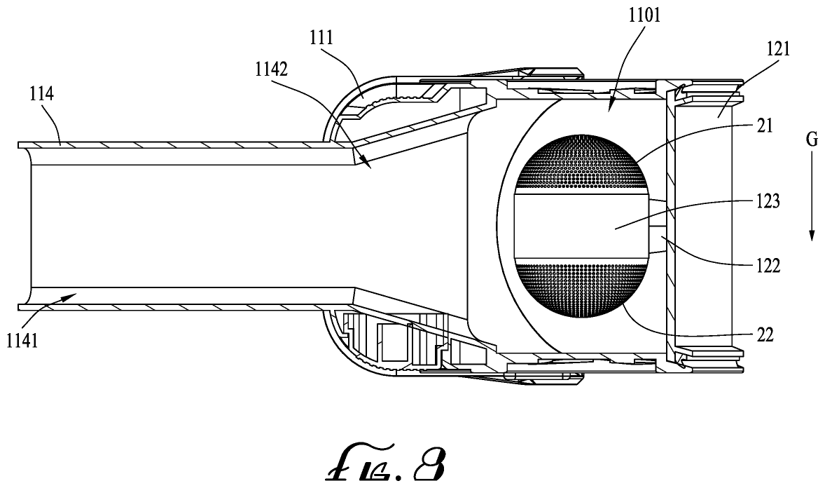

With reference to FIGS. 2, 3, and 6, the dust-air separation device 100 comprises a housing 10 and a first separator 21 and a second separator 22 disposed within the cyclone separation chamber 1101. The housing 10 is formed with an air inlet channel 1141, a cyclone separation chamber 1101, and a dust collection chamber 1111. The air inlet channel 1141 and the dust collection chamber 1111 are both connected to the cyclone separation chamber 1101 and an air outlet 1211 is formed on the housing 10; specifically, the cyclone separation chamber 1101 is a cylindrical chamber. The first separator 21 and the second separator 22 are arranged sequentially along the axial direction of the cyclone separation chamber 1101 (refer to the direction indicated by arrow G in FIG. 8). The axis E of the air inlet channel 1141 is tangential to the outer peripheral wall of the cyclone separation chamber 1101. This arrangement makes the airflow with impurities, dust, etc. enter the cyclone separation chamber 1101 from the air inlet channel 1141 and then undergo high-speed circular motion in the cyclone separation chamber 1101 (refer to the path indicated by arrow A in FIG. 2). This allows impurities, dust, etc. to enter the dust collection chamber 1111 under the action of centrifugal force (see the path indicated by arrow B in [Figure] 2). The airflow after removing dust and impurities is discharged from the first separator 21 and the second separator 22, thus realizing the separation of dust and air; in addition, both the first separator 21 and the second separator 22 are connected to the air outlet 1211 and the air inlet of the air duct 201 is connected to the air outlet 1211. The airflow after removing dust and impurities then flows out from the first separator 21 and the second separator 22, enters the air duct 201 of the handheld device 200, and is filtered and discharged (see the path indicated by arrow C in FIG. 2). In this way, the vacuuming operation is completed.

In this embodiment, an air deflector 122 extending along the airflow direction (refer to the direction indicated by arrow D in FIG. 2) within the cyclone separation chamber 1101 is provided on the inner peripheral wall of the cyclone separation chamber 1101. It can be understood that the airflow direction within the cyclone separation chamber 1101 is the circumferential direction of the cyclone separation chamber 1101; the first separator 21 and the second separator 22 are located on opposite sides of the air deflector 122 along the axial direction of the cyclone separation chamber 1101.

The dust-air separation device 100 of the embodiments of the present application comprises a first separator 21 and a second separator 22 and the inner peripheral wall of the cyclone separation chamber 1101 is provided with an air deflector. The outer surfaces of the first separator 21 and the second separator 22 may be curved surfaces. The air deflector extends along a flow direction of the airflow within the cyclone separation chamber 1101. At the same time, the first separator 21 and the second separator 22 are located on opposite sides of the air deflector 122 along an axial direction of the cyclone separation chamber 1101. In this way, airflow carrying impurities, dust, etc. flows through the air inlet channel 1141 into the cyclone separation chamber 1101 and then flows under the guidance of the air deflector 122. The air deflector 122 divides the airflow into two parts. The two parts of the airflow are discharged from the first separator 21 and the second separator 22, respectively, and are then finally discharged through the air outlet 1211 into the subsequent device (i.e., the air duct 201 of the handheld device 200), wherein the airflow is divided into two parts under the guidance of the air deflector 122. The two parts of the airflow are rotated to opposite sides of the air deflector 122 and discharged from the first separator 21 and the second separator 22, respectively, located on opposite sides of the air deflector 122. This reduces the mutual impact of the two parts of the airflow, reduces vortex flow within the cyclone separation chamber 1101, increases airflow patency, increases the flow rate of the airflow, and improves dust-air separation efficiency. At the same time, it can also reduce the cessation of rotation directly into the first separator 21 and the second separator 22 after some of the dust is impacted by airflow, reducing the dust contained in the airflow discharged from the cyclone separation chamber 1101 and thereby avoiding subsequent filter clogging; at the same time, the two parts of the airflow are discharged from the first separator 21 and second separator 22, located on both sides of the air deflector, respectively. In this way, the problem of uneven local flow rate caused by the two parts of the air being concentrated in one position can be avoided, improving the smoothness of airflow and dust-air separation performance; in addition, the arrangement of the first separator 21 and the second separator 22 can increase the exhaust area of the cyclone separation chamber 1101, which helps reduce the exhaust resistance and further improve the dust-air separation efficiency.

The smoothness of the flow of air in the dust-air separation device 100 of the embodiments of the present application is good, the loss of airflow kinetic energy is small, and the efficiency of dust-air separation is high, so that the vacuum cleaner 1 with the dust-air separation device 100 does not experience filter clogging and sudden drops in suction power. At the same time, the loss of airflow kinetic energy is reduced, which can also make the vacuum cleaner 1 have better vacuuming performance.

In the present embodiment, with reference to FIG. 2, a battery 260 is also provided in the outer housing 210. The battery 260 is used to power the motor 230 to realize the wireless operation of the vacuum cleaner 1; the housing 10 and the outer housing 210 are mechanically connected, which can ensure the sealing connection between the air outlet 1211 and the air inlet of the air duct 201 and prevent air leakage. Specifically, a removable connection between the housing 10 and the outer housing 210 can be used, such as screwing, snapping, articulating, etc. This arrangement can allow the handheld device 200 to be detached from the dust-air separation device 100 to facilitate easy cleaning of dust and debris in the dust collection chamber 1111.

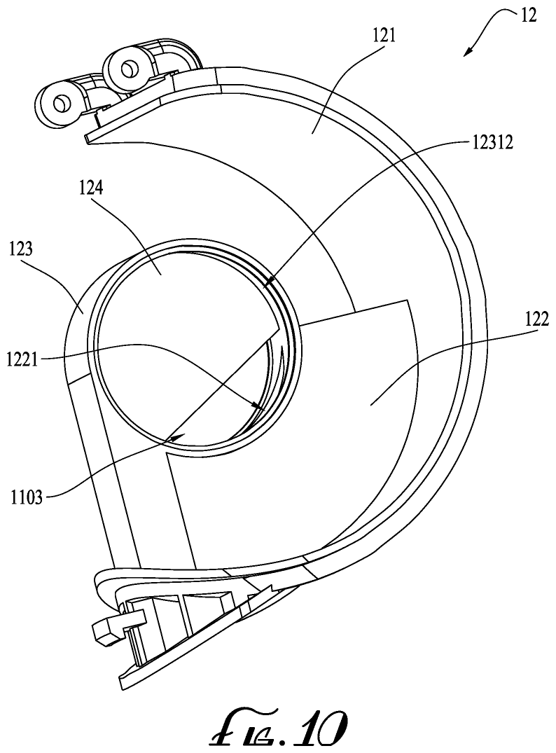

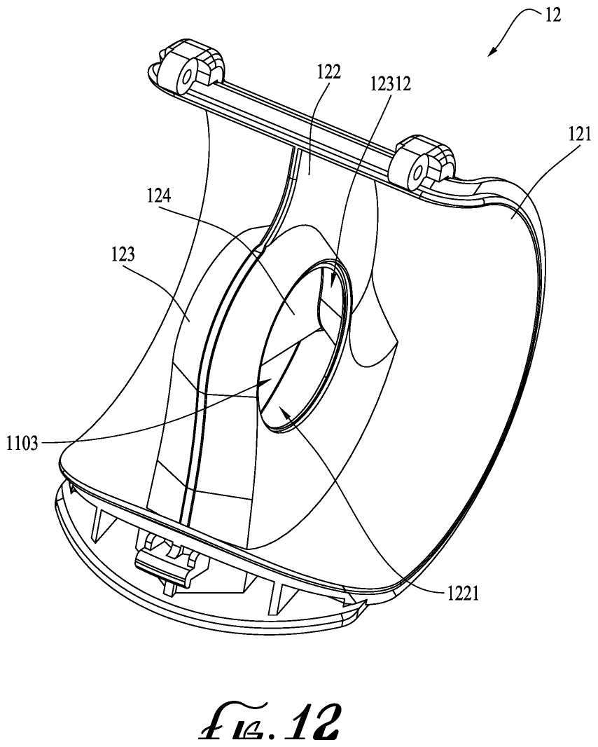

In another embodiment of the present application, with reference to FIGS. 10 and 12, the thickness of the air deflector 122 of the dust-air separation device 100 gradually increases along the direction of airflow within the cyclone separation chamber 1101. In this way, the airflow entering the cyclone separation chamber 1101 first touches the end portion of the air deflector 122 with a smaller width and is divided into two parts, and with gradually widening of the width of the air deflector 122, and the two parts of the airflow are separated more and more, the diversion effect of the air deflector 122 becomes better, the airflow becomes more smother, and the he separation effect of dust and air becomes better; specifically, the air deflector 122 gradually changes from a sharp edge to a wide surface along the flow direction of the airflow in the cyclone separation chamber 1101. In this way, the airflow first hits the sharp edge and then is divided into two parts, reducing the impact area of the airflow and the air deflector 122, thereby reducing the kinetic energy loss and turbulence of the airflow and improving the smoothness of the airflow and the dust-air separation efficiency; or, with reference to FIG. 12, along the flow direction of the airflow in the cyclone separation chamber 1101, the air deflector 122 has a multi-section structure, and the thickness of the front section is always greater than the thickness of the back section; of course, in other embodiments, the air deflector 122 may also adopt other structures, which are not defined here. In addition, the air deflector 122 gradually changes from a sharp edge to a wide surface along the flow direction of the airflow in the cyclone separation chamber 1101. This structural design makes the opposite sides of the air deflector 122 along the axial direction of the cyclone separation chamber 1101 be smooth slopes. This can ensure that the airflow rotates along the direction of the inclined plane and finally enters the dust collection chamber 1111. In addition, comparing the structure of the multi-segment air deflector 122 with the air deflector 122 of this structural design, the airflow does not have the problem of hitting the steps, which reduces the flow resistance of the airflow, reduces the problem of turbulence in the cyclone separation chamber 1101, and helps improve dust-air separation efficiency.

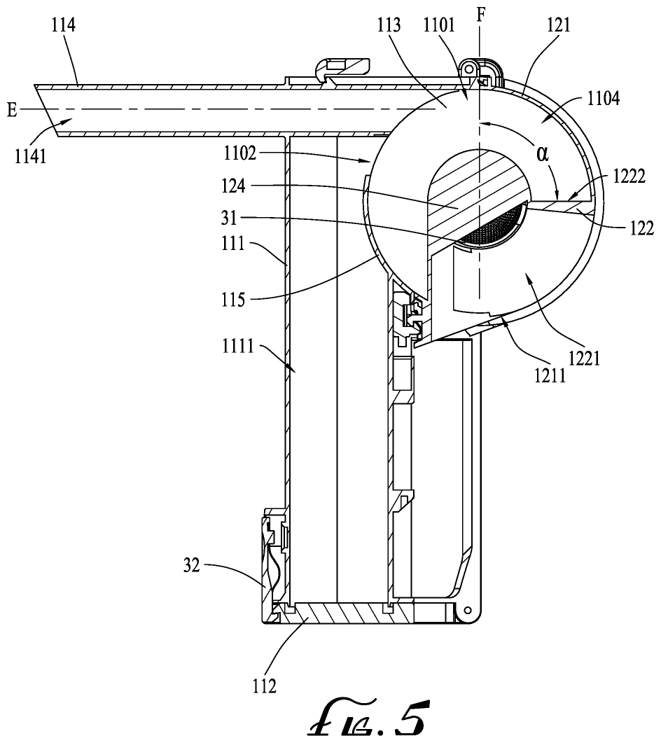

In another embodiment of the present application, with reference to FIG. 5, the plane of the dust-air separation device 100 provided perpendicular to the axis of the cyclone separation chamber 1101 is an auxiliary plane and an auxiliary line F is provided on the auxiliary plane. The auxiliary line F is perpendicular to the axis E of the air inlet channel 1141; the projection line of the air intake edge 1222 of the air deflector 122 on the auxiliary plane is set at an included angle with the auxiliary line F and the included angle α ranges from 30° to 120°. It can be understood that the air intake edge 1222 of the air deflector 122 is the edge that first makes contact with the airflow of the air deflector 122, such as the sharp edge described above or the end surface of the multi-segment air deflector 122 described above that first makes contact with the airflow; in addition, this angle range is set so that a circulation channel 1104 is formed between the air inlet channel 1141 and the air deflector 122. In this way, after the airflow enters the cyclone separation chamber 1101 from the air inlet channel 1141, it is to pass through the circulation channel 1104 before impacting and making contact with the air deflector 122 and being diverted, thereby preventing hair in the airflow from building up on the air intake edge 1222 of the air deflector 122 to cause clogging. Specifically, the included angle α may be 30°, 35°, 40°, 45°, 50°, 55°, 60°, 65°, 70°, 75°, 80°, 85°, 90°, 95°, 100°, 105°, 110°, 115°, or 120°. If the included angle α is set too small, the distance of the circulation channel 1104 will be short, and the airflow will flow a short distance within the cyclone separation chamber 1101 before directly impacting the air deflector 122, allowing hair to accumulate easily on the air intake edge 1222; if the included angle α is set too large, the distance of the circulation channel 1104 will be long and the length of the air deflector 122 will short, making it impossible for it to have good diversion performance and affecting dust-air separation performance.

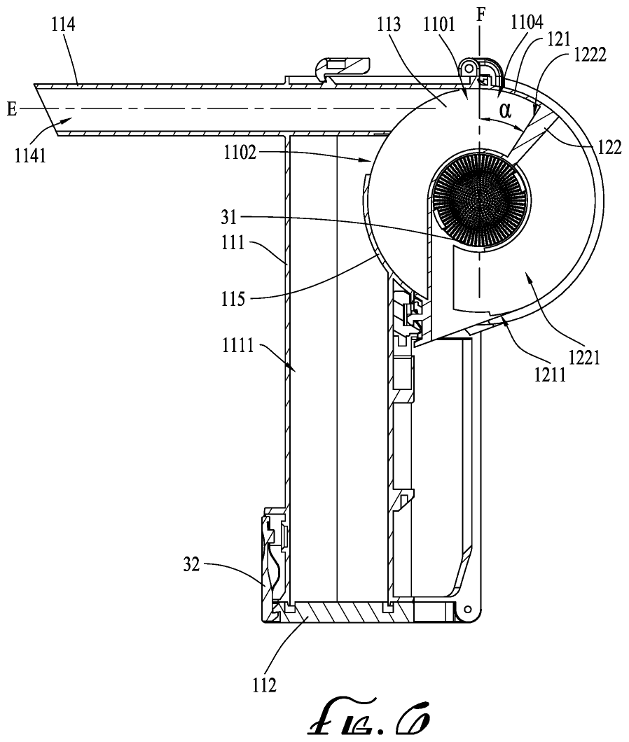

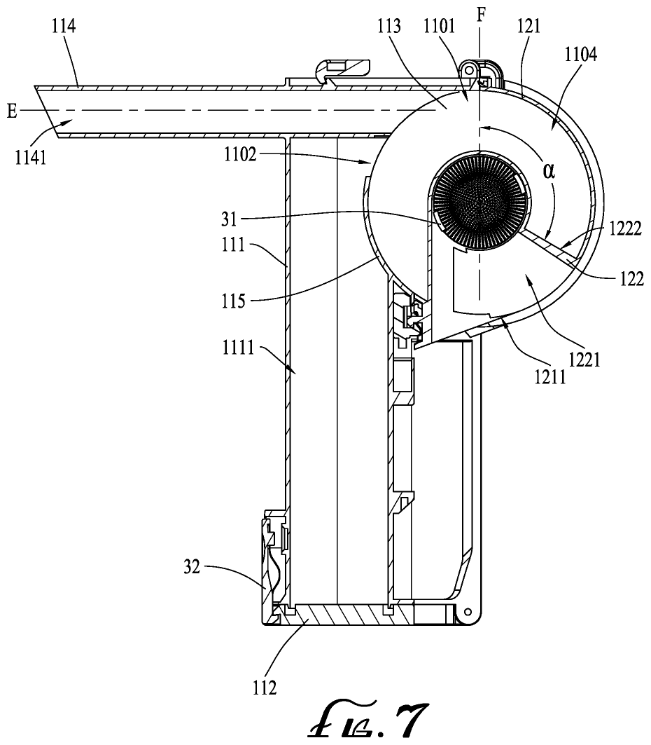

For example, with reference to FIG. 5, the auxiliary plane extends over the air intake edge 1222 of the air deflector 122; that is, the projection line of the air intake edge 1222 of the air deflector 122 on the auxiliary plane coincides with the air intake edge 1222 of the air deflector 122, and the included angle α is 90°; with reference to FIG. 6, the auxiliary plane extends over the air intake edge 1222 of the air deflector 122; that is, the projection line of the air intake edge 1222 of the air deflector 122 on the auxiliary plane coincides with the air intake edge 1222 of the air deflector 122, and the included angle α is 30°; with reference to FIG. 7, the auxiliary plane extends over the air intake edge 1222 of the air deflector 122; that is, the projection line of the air intake edge 1222 of the air deflector 122 on the auxiliary plane coincides with the air intake edge 1222 of the air deflector 122, and the included angle α is 120°.

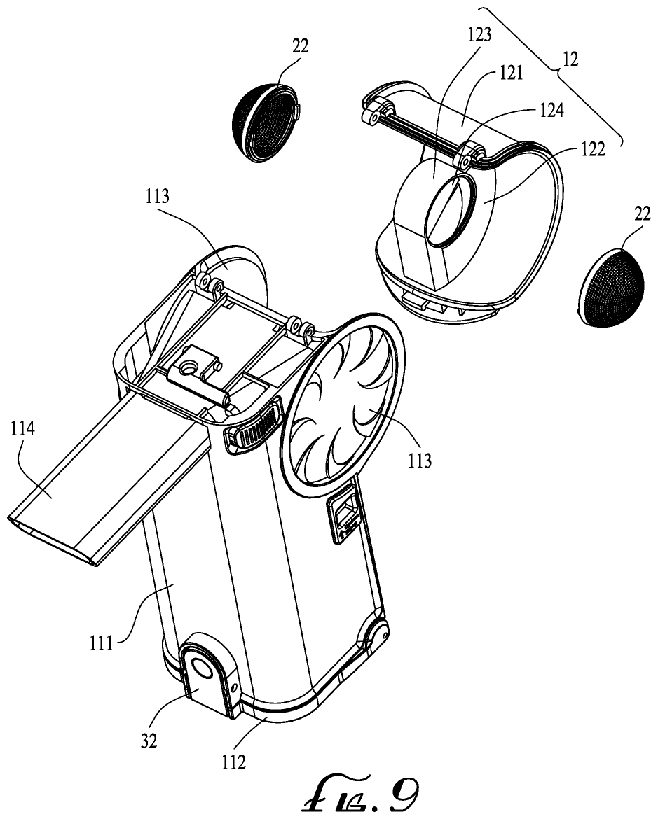

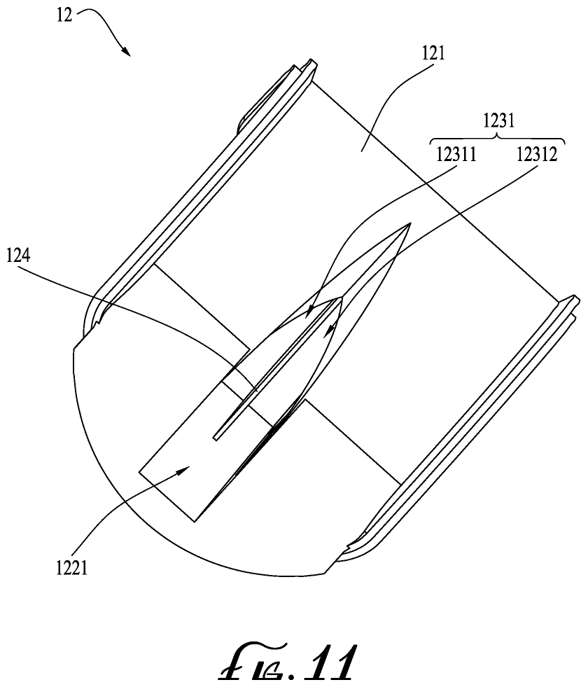

In another embodiment of the present application, with reference to FIGS. 9, 10, and 11, the dust-air separation device 100 provided with the dust-air separation device 100 further comprises a connecting column 123, with a connecting hole 1231 formed in the connecting column 123, and the first separator 21 and the second separator 22 are mounted on opposite ends of the connecting column 123 and are connected to the connecting hole 1231; the connecting column 123 is mounted on the air deflector 122, the interior of the air deflector 122 forms an exhaust channel 1221, and the exhaust channel 1221 is connected to the air outlet 1211 and the connecting hole 1231. Specifically, the airflow discharged from the first separator 21 and the second separator 22 merges in the connecting hole 1231 in the connecting column 123 and then is directly discharged from the exhaust channel 1221 in the air deflector 122. In this way, the discharge path of the entire airflow is located inside the connecting column 123 and the air deflector 122, without the need to arrange an exhaust structure at other positions in the cyclone separation chamber 1101. Thus, there are few blocking parts for the airflow in the cyclone separation chamber 1101, the smoothness of the airflow is good, and dust-air separation efficiency is high.

In another embodiment of the present application, with reference to FIGS. 9, 10 and 11, the provided dust-air separation device 100 [sic] further comprises a partition 124 mounted in the connecting hole 1231 and dividing the connecting hole 1231 into a first hole segment 12311 and a second hole segment 12312. The first hole segment 12311 is connected to the first separator 21 and the exhaust channel 1221 and the second hole segment 12312 is connected to the second separator 22 and the exhaust channel 1221. The airflow discharged by the first separator 21 and the airflow discharged by the second separator 22 flow into the exhaust channel 1221 through the first hole segment 12311 and the second hole segment 12312, respectively, which can prevent the airflow discharged by the first separator 21 and the second separator 22 from impacting each other, thereby improving the smoothness of the airflow and improving dust-air separation performance. Specifically, the partition 124 is arranged perpendicularly to the axis of the connecting hole 1231, the connecting hole 1231 and the exhaust channel 1221 are arranged perpendicularly, the inner wall of the connecting hole 1231 forms a connecting port, the connecting hole 1231 is connected to the exhaust channel 1221, and the partition 124 is located in the middle of the connecting port, so that the first hole segment 12311 and the second hole segment 12312 are connected with each other. In this way, the connection between the first separator 21 and the exhaust channel 1221 and the connection between the second separator 22 and the exhaust channel 1221 are realized. The structure is ingeniously designed, simple in structure, convenient to manufacture, and has good airflow smoothness, which is beneficial to improving the performance and efficiency of dust-air separation.

In another embodiment of the present application, with reference to FIGS. 9, 10, and 11, the ratio of the projected area along the axial direction of the connecting hole 1231 to the cross-sectional area of the connecting hole 1231 of the partition 124 of the provided dust-air separation device 100 is greater than 0.75. With this arrangement, the airflow of the first separator 21 into the first hole segment 12311 and the airflow of the second separator 22 into the second hole segment 12312 can be mostly separated, thereby reducing the impact between the two airflows and improving the smoothness of exhaust and dust-air separation performance; if the ratio of the projected area of the partition 124 along the axial direction of the connecting hole 1231 to the cross-sectional area of the connecting hole 1231 is set too small, the airflow of the first hole segment 12311 and the second hole segment 12312 cannot be separated, thereby causing airflow impact, affecting the smoothness of the airflow and dust-air separation performance; specifically, the ratio of the projected area of the partition 124 along the axial direction of the connecting hole to the cross-sectional area of the connecting hole 1231 may be 0.75, 0.78, 0.81, 0.84, 0.87, 0.9, 0.93, 0.96, 0.97, or 1.

As shown in FIG. 8, when the projected area of the partition 124 along the axial direction of the connecting hole 1231 is smaller than the cross-sectional area of the connecting hole 1231, an exhaust area 1103 connected to the first hole segment 12311 and the second hole segment 12312 is formed between the side of the partition 124 facing the connecting port and the connecting port. The exhaust area 1103 can increase the exhaust area of the airflow in the first hole segment 12311 and the airflow in the second hole segment 12312 flowing into the exhaust channel 1221, thereby increasing the smoothness of airflow discharge and improving the performance and efficiency of dust-air separation.

In another embodiment of the present application, the outer surface of the first separator 21 and the outer surface of the second separator 22 of the provided dust-air separation device 100 are curved surfaces. With this arrangement, the outer surface of the first separator 21 and the outer surface of the second separator 22 are smooth, so that the hair in the airflow does not tangle easily on the first separator 21 and the second separator 22, avoiding the clogging of the first separator 21 and the second separator 22, improving the smoothness of airflow discharge, and achieving better dust-air separation performance; wherein, it must be noted that the first separator 21 and the second separator 22 are provided with multiple through holes for the flow of air to realize the exhaust of the cyclone separation chamber 1101; specifically, the first separator 21 and the second separator 22 can be in the shape of a hemisphere, a semi-ellipse, etc. Their specific shapes can be selected according to actual needs and are not defined here; in addition, between the first separator 21 and the connecting column 123 and between the second separator 22 and the connecting column 123, fixed connections are adopted, such as welding, bonding, etc. Detachable connections can also be used, such as screwing, snapping, etc. Wherein, adopting the detachable connection mode can facilitate the cleaning of the first separator 21, the second separator 22, the connecting column 123, the air deflector 122, and other components.

In another embodiment of the present application, with reference to FIG. 8, the opposite side walls of the air outlet end 1142 of the air inlet channel 1141 of the provided dust-air separation device 100 along the axial direction of the cyclone separation chamber 1101 are gradually separated along the flow direction of the airflow. In this way, after the airflow with dust and impurities passes through the air outlet end 1142 of the air inlet channel 1141 and expands, the airflow enters the cyclone separation chamber 1101 toward the opposite sides of the cyclone separation chamber 1101 along the axial direction as much as possible, thereby reducing impurities and dust hanging on the air deflector 122 or directly rushing into the first separator 21 and the second separator 22, reducing the risk of clogging of the dust-air separation device 100, and improving dust-air separation efficiency. It can be understood that the air outlet end 1142 of the air inlet channel 1141 refers to the end of the air inlet channel 1141 close to the cyclone separation chamber 1101; specifically, the opposite two side walls of the air outlet end 1142 of the air inlet channel 1141 expand outward obliquely or in a circular arc, so that the width of the air inlet channel 1141 close to the end of the cyclone separation chamber 1101 is gradually increased from 0 mm to 15 mm. Of course, other expansion methods can also be adopted. The specific expansion method and expansion size can be selected according to actual needs and are not defined here.

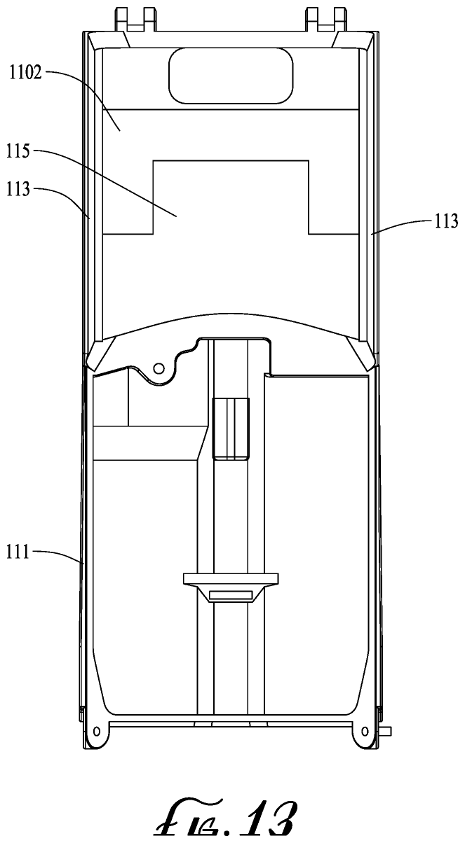

In another embodiment of the present application, with reference to FIG. 13, the inner peripheral wall of the cyclone separation chamber 1101 of the provided dust-air separation device 100 is formed with a dust outlet 1102 that is connected to the dust collection chamber 1111, and the opposite sides of the dust outlet 1102 along the axial direction of the cyclone separation chamber 1101 are flush with both ends of the cyclone separation chamber 1101. In this way, impurities and dust in the airflow can be thrown directly into the dust outlet 1102 along the two ends of the cyclone separation chamber 1101 under the action of centrifugal force without accumulating at the connection between the dust outlet 1102 and the end surface, thereby effectively improving dust-air separation efficiency. Specifically, the dust outlet 1102 is a U-shaped structure with a downward opening. With this arrangement, the airflow with a slower flow rate on opposite sides along the axial direction of the cyclone separation chamber 1101 will first reach the dust outlet, thereby ensuring that the dust and impurities located therein can smoothly enter the dust collection chamber 1111 and reducing the accumulation of dust and impurities in the cyclone separation chamber 1101 and the risk of clogging; wherein, the height range of the middle portion of the dust outlet 1102 is 12 mm-20 mm and the width range of the openings on both sides of the dust outlet 1102 is 12 mm-20 mm.

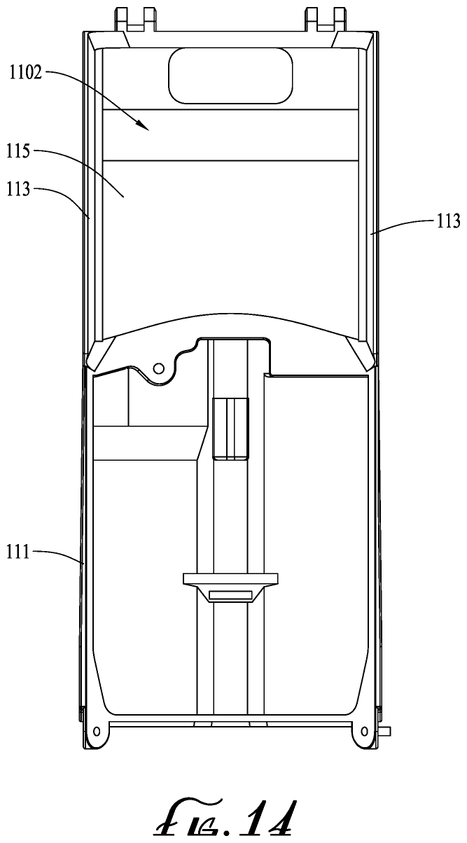

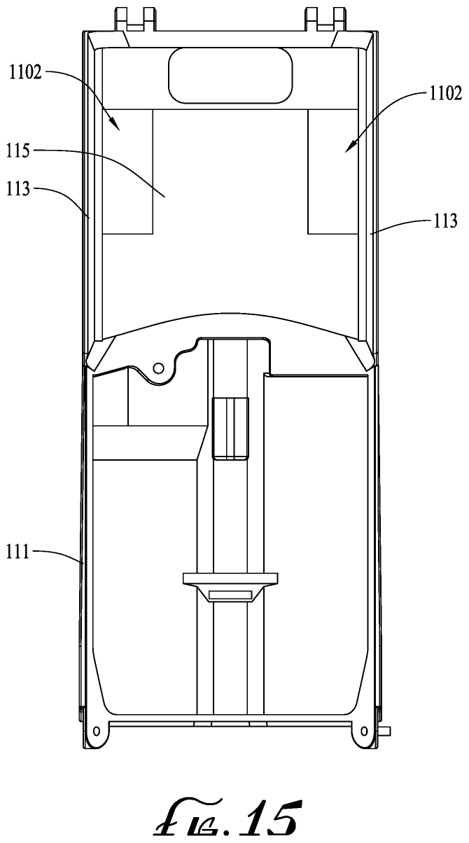

In some other embodiments, with reference to FIG. 14, the dust outlet 1102 may also be in the shape of a long strip. Of course, in other embodiments, with reference to FIG. 15, there are multiple dust outlets 1102. As an example, the number of dust outlets 1102 is two and the two dust outlets 1102 are distributed axially along the cyclone separation chamber 1101. Along the axial direction of the cyclone separation chamber 1101, the two dust outlets 1102 are flush with the two sides of the cyclone separation chamber 1101.

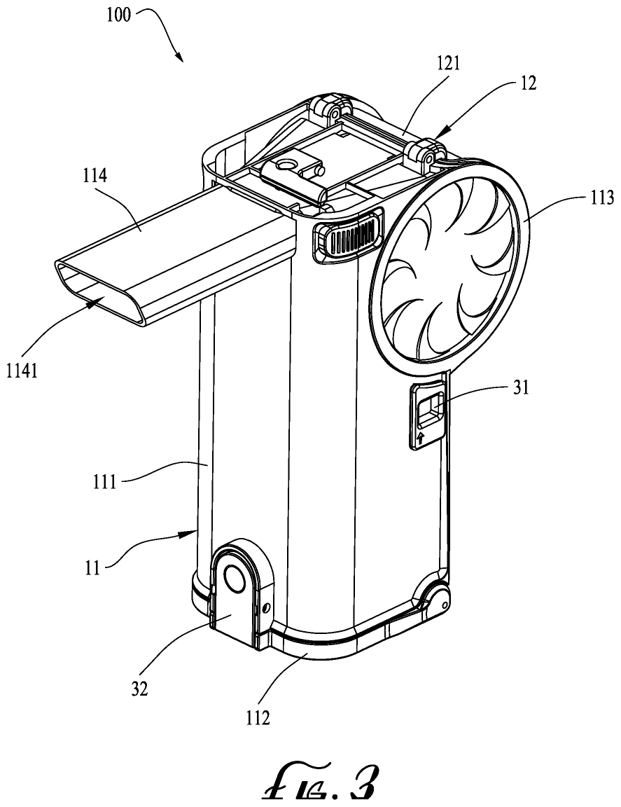

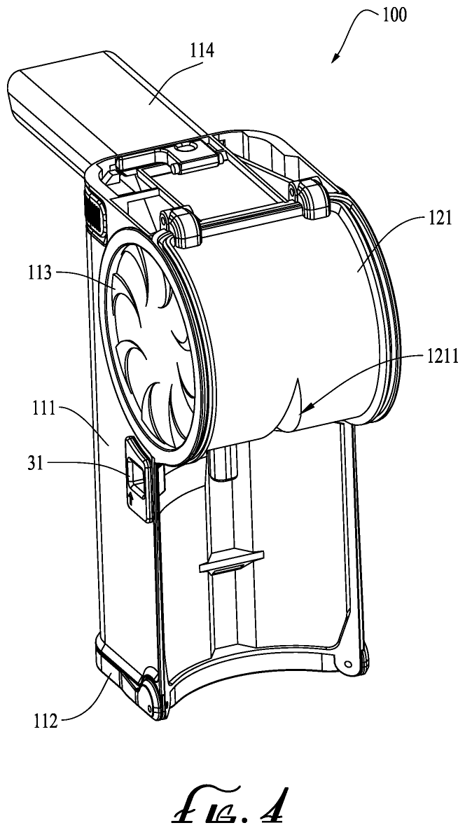

In another embodiment of the present application, with reference to FIGS. 3, 4, and 9, the housing 10 of the provided dust-air separation device 100 comprises an air outlet plate 121 and a dust cup 11, and an air inlet channel 1141 and a dust collection chamber 1111 are formed in the dust cup 11; the air outlet plate 121 is detachably mounted on the dust cup 11 and surrounds the dust cup 11 to form a cyclone separation chamber 1101, the air deflector 122 is mounted on the air outlet plate 121, and the air outlet is formed on the air outlet plate 121. The air outlet plate 121 and the dust cup 11 of the dust-air separation device 100 can be disassembled, thereby opening the cyclone separation chamber 1101 to facilitate the emptying of the dirt inside the cyclone separation [chamber]; specifically, when dust, hair, and other dirt are accumulated in the cyclone separation chamber 1101, the air outlet plate 121 is disassembled from the dust cup 11 to open the cyclone separation chamber 1101. The dirt in the cyclone separation chamber 1101 can be poured out directly. The user does not need to touch the dirt inside the cyclone separation chamber directly by hand and the cleaning operation is simple and convenient.

In this embodiment, the dust-air separation device 100 further comprises a first lock 31, one end of the air outlet plate 121 is rotatably connected with the dust cup 11, and the other end of the air outlet plate 121 is connected with the dust cup 11 through the first lock 31. When the cyclone separation chamber 1101 needs to be cleaned, the cyclone separation chamber 1101 can be opened by directly opening the first lock 31 and then flipping the air outlet plate 121. The opening operation of the cyclone separation chamber 1101 is simple and convenient. Specifically, one end of the air outlet plate 121 is connected to the dust cup 11 through an elastic hinge and the first lock 31 is an elastic lock. In this way, after pressing the elastic lock, the air outlet plate 121 can automatically rotate relative to the dust cup 11, thereby opening the cyclone separation chamber 1101. The operation is simpler and more portable; of course, in other embodiments, the dust outlet plate can also be connected to the dust cup 11 through other disassembly methods, such as screwing, snapping, etc. Its specific connection method can be selected according to the actual situation and is not defined here.

With reference to FIGS. 3, 4, and 13, the dust cup 11 comprises a dust cup body 111, a bottom cover 112, an air inlet tube 114, a dust outlet plate 115, and two end plates 113. An air inlet channel 1141 is formed in the air inlet tube 114. A dust collection chamber 1111 is formed inside the dust cup body 111. The bottom of the dust cup body 111 forms a dirt discharge outlet connected to the dust collection chamber 1111. One side of the bottom cover 112 is rotatably connected to one side of the dirt discharge outlet through an elastic hinge. The other end of the bottom cover 112 is connected to the other side of the dirt discharge outlet through the second elastic lock and seals the dirt discharge outlet. Then, when the dust collection chamber 1111 needs to be cleaned, the second elastic lock can be pressed, and the bottom cover 112 can automatically pop open to open the dirt discharge outlet, and the dirt in the dust collection chamber 1111 can be automatically discharged from the dirt discharge outlet; the dust outlet plate 115 is arranged on the side of dust cup 11. The air inlet tube 114 is inserted into the dust cup body 111 from the other side of the dust cup body 111. The two end plates 113 are installed on the opposite sides of the dust cup body 111 and connected with both ends of the dust outlet plate 115, and the upper edge of the dust outlet plate 115, the sides of the two end plates 113, and the lower side wall of the air inlet tube 114 surround and form the dust outlet 1102. The upper end of the air outlet plate 121 is rotatably connected to the dust cup body 111. The lower end of the air outlet plate 121 is connected to the dust cup body 111 through the second lock 32, and when the second lock 32 (such as elastic lock, etc.) locks the air outlet plate 121 on the dust cup body 111, the two end plates 113, the air outlet plate 121, the air inlet tube 114, the dust outlet plate 115, and the dust cup body 111 jointly form the cyclone separation chamber 1101. Wherein, tit should be noted that the air outlet plate 121 is sealed and connected with the two end plates 113 and the dust cup body 111 through a sealing ring, thereby avoiding air leakage in the cyclone separation chamber 1101 and improving the vacuuming performance of the vacuum cleaner 1; in addition, the two end plates 113, the air inlet tube 114, the dust outlet plate 115, and the dust cup body 111 can be formed into an integrated structure through injection molding or 3D printing, thereby reducing production procedures and saving production costs. Similarly, the air outlet plate 121, air deflector 122, partition 124, and connecting column 123 may also form an integrally structured air outlet bracket 12 through an integrate molding process such as injection molding or 3D printing, thereby reducing production procedures and saving production costs.

In another embodiment of the present application, a vacuum cleaner 1 is provided and comprises the dust-air separation device 100 described above.

In the vacuum cleaner 1 of the embodiments of the present application, due to the use of the above dust-air separation device 100, the smoothness of the flow of air in the dust-air separation device 100 is good, the loss of airflow kinetic energy is small, and the efficiency of dust-air separation is high, so that the vacuum cleaner 1 does not experience filter clogging and sudden drops in suction power. At the same time, the loss of airflow kinetic energy is reduced, which can also make the vacuum cleaner 1 have better vacuuming performance. Since the vacuum cleaner 1 of the embodiments of the present application adopts the technical solution of all the above embodiments, all the benefits provided by the technical solution of the above embodiments are also provided and are not described here one-by-one again.

The working process of the vacuum cleaner 1 according to the embodiments of the present application is described in detail below with reference to FIGS. 1 and 2.

When the vacuum cleaner 1 is operating, the motor 230 is activated, and the motor 230 drives the impeller 240 to draw air, causing negative pressure in the air duct 201, the cyclone separation chamber 1101, and the air inlet channel 1141, so that airflow with dust and debris enters the cyclone separation chamber 1101 from the air inlet channel 1141 and undergoes circular motion within the cyclone separation chamber 1101 to be divided into two parts by the diversion effect of the air deflector 122; and under the centrifugal force of the airflow rotation, most of the dust and impurities in the two airflows will enter the dust collection chamber 1111, removing most of the dust and impurities; the two parts of the airflow after most of the dust and impurities are removed will be discharged into the exhaust channel 1221 through the first separator 21 and the second separator 22 before entering the air duct 201 in the handheld device 200 and then the air inlet filter 220. At this time, most of the remaining dust and impurities in the airflow will be adsorbed on the air inlet filter 220; the airflow passing through the air inlet filter 220 is driven by the impeller 240 to enter the air outlet filter 250. At this time, the small portion of dust and impurities remaining in the airflow can be absorbed by the air outlet filter 250 and then discharged from the outer housing 210. This can ensure that most of the dust and impurities in the airflow are mostly intercepted in the vacuum cleaner 1, ensuring that the air discharged from the vacuum cleaner 1 is clean and avoiding secondary pollution.

For ease of reference, the reference numbers in the figure are:

| | | |
|---|---|---|
| 1-Vacuum cleaner | 10-Housing | 11-Dust cup |
| 12-Air outlet bracket | 21-First separator | 22-Second separator |
| 31-First lock | 32-Second lock | 100-Dust-air separation device |
| 111-Dust cup body | 112-Bottom cover | 113-End plate |
| 114-Air inlet tube | 115-Dust outlet plate | 121-Air outlet plate |
| 122-Air deflector | 123-Connecting column | 124-Partition |
| 200-Handheld device | 201-Air duct | 210-Outer housing |
| 220-Air inlet filter | 230-Motor | 240-Impeller |
| 250-Air outlet filter | 260-Battery | 1101-Cyclone separation chamber |
| 1102-Dust outlet | 1103-Exhaust area | 1104-Circulation channel |
| 1111-Dust collection chamber | 1141-Air inlet channel | 1142-Air outlet end |
| 1211-Air outlet | 1221-Exhaust channel | 1222-Air intake edge |
| 1231-Connecting hole | 12311-First hole segment | 12312-Second hole segment. |

What is claimed is:

1. A dust-air separation device comprising:
a housing having an air inlet channel;
a cyclone separation chamber;
and a dust collection chamber formed therein;
wherein the air inlet channel and the dust collection chamber are both connected to the cyclone separation chamber and an air outlet is formed on the housing;
wherein the cyclone separation chamber further comprises a first separator, a second separator, an air deflector located between the first separator and the second separator on an inner peripheral wall of the cyclone separation chamber along the direction of an airflow in the cyclone separation chamber;
wherein the first separator and the second separator are both connected to the air outlet.

2. The dust-air separation device according to claim 1, wherein the thickness of the air deflector increases along a direction of airflow within the cyclone separation chamber.

3. The dust-air separation device according to claim 1, wherein a plane perpendicular to an axis of the cyclone separation chamber is an auxiliary plane on which an auxiliary line is provided, the auxiliary line also being perpendicular to an axis of the air inlet channel; a projection line of an air intake edge of the air deflector on the auxiliary plane is offset from the auxiliary line at an angle ranging from 30° to 120°.

4. The dust-air separation device according to claim 1, wherein the dust-air separation device further comprises a connecting column formed with a connecting hole within the connecting column, the first separator and the second separator being mounted on opposite ends of the connecting column and both connecting to the connecting hole; the connecting column being mounted on the air deflector, the interior of the air deflector forming an exhaust channel, and the exhaust channel connecting to the air outlet and the connecting hole.

5. The dust-air separation device according to claim 4, wherein the dust-air separation device further comprises a partition mounted within the connecting hole which divides the connecting hole into a first hole segment that connects to the first separator and the exhaust channel and a second hole segment that connects to the second separator and the exhaust channel.

6. The dust-air separation device according to claim 5, wherein a ratio of the projected area of the partition along the axial direction of the connecting hole to the cross-sectional area of the connecting hole is greater than 0.75.

7. The dust-air separation device according to claim 1, wherein the air inlet channel is further comprised of opposite side walls and an air outlet end along the axial direction of the cyclone separation chamber such that the side walls increase in distance from each other along the direction of the airflow.

8. The dust-air separation device according to claim 7, wherein the opposite side walls of the air outlet end of the air inlet channel expand outward in an oblique circular arc.

9. The dust-air separation device according to claim 1 wherein the cyclone separation chamber is formed with a dust outlet connected to the dust collection chamber such that the opposite sides of the dust outlet along the axial direction of the cyclone separation chamber are flush with both ends of the cyclone separation chamber.

10. The dust-air separation device according to claim 9 wherein the dust outlet is a U-shaped structure with a downward facing opening.

11. The dust-air separation device according to claim 9 wherein the dust-air separation device further comprises at least two dust outlets and the at least two dust outlets are distributed axially along the cyclone separation chamber.

12. The dust-air separation device according to claim 6, wherein the housing comprises an air outlet plate and a dust cup;
the air outlet plate is detachably mounted on the dust cup and surrounds the dust cup to form the cyclone separation chamber,
the air deflector is mounted on the air outlet plate, and,
the air outlet is formed on the air outlet plate.

13. The dust-air separation device according to claim 12 wherein the dust-air separation device also comprises a locking mechanism, one end of the air outlet plate is rotatably connected with the dust cup, and the other end of the air outlet plate is connected with the dust cup through the locking mechanism.

14. The dust-air separation device according to claim 1 wherein the outer surface of the first separator and the outer surface of the second separator of the dust-air separation device are curved surfaces.

15. The dust-air separation device according to claim 14 wherein the first separator and the second separator are in the shape of a semi-ellipse.

16. A vacuum cleaner comprising:
a dust-air separation device comprising:
a housing having an air inlet channel;
a cyclone separation chamber;
and a dust collection chamber formed therein;
wherein the air inlet channel and the dust collection chamber are both connected to the cyclone separation chamber and an air outlet is formed on the housing;
wherein the cyclone separation chamber further comprises a first separator, a second separator, an air deflector located between the first separator and the second separator on an inner peripheral wall of the cyclone separation chamber;
wherein the first separator and the second separator are both connected to the air outlet; and
a handheld device comprising an outer housing, an air inlet filter, a motor, an impeller and an air outlet filter;
an air duct is formed in the outer housing, wherein the air inlet filter, the motor, the impeller and the air outlet filter are arranged in the air duct, wherein the air inlet of the air duct is connected to the air outlet of the dust-air separation device.

17. The vacuum cleaner according to claim 16 wherein the air inlet filter, the motor, and the air outlet filter are sequentially arranged in the air duct, from top to bottom.

18. The vacuum cleaner according to claim 16 wherein the housing and the outer housing are mechanically connected which can ensure the sealing connection between the air outlet, and the air inlet of the air duct.

19. A dust-air separation device comprising:
a housing having an air inlet channel;
a cyclone separation chamber;
and a dust collection chamber formed therein;
wherein the air inlet channel and the dust collection chamber are both connected to the cyclone separation chamber and an air outlet is formed on the housing;
wherein the cyclone separation chamber further comprises a first separator, a second separator, and a connecting column formed with a connecting hole within the connecting column, the first separator and the second separator being mounted on opposite ends of the connecting column and both are connected to the connecting hole;
wherein the connecting hole is connected to the air outlet.

20. The dust-air separation device according to claim 19, wherein the dust-air separation device further comprises an air deflector located between the first separator and the second separator on an inner peripheral wall of the cyclone separation chamber;
wherein the connecting column being mounted on the air deflector and the interior of the air deflector form an exhaust channel, and the exhaust channel connects to the air outlet and the connecting hole.
